(19) United States
(12) Patent Application Publication
(10) Pub. No.: US 2002/0015578 A1
(43) Pub. Date: Feb. 7, 2002

(54) Title selecting device

(75) Inventors: Takahiko Ogikubo, Saitama (JP); Kazuhiro Oshita, Shizuoka (JP)

Correspondence Address: SUGHRUE, MION, ZINN, MACPEAK & SEAS, 2100 Pennsylvania Avenue, N.W., Washington, DC, 20037-3202, US

(73) Assignee: PIONEER CORPORATION

(21) Appl. No.: 09/921,715

(22) Filed: Aug. 6, 2001

(30) Foreign Application Priority Data
Aug. 4, 2000 (JP) 2000-236566

(51) Int. Cl. H04N 5/783

(52) U.S. Cl. 386/70; 386/95

(57) ABSTRACT

A title selecting device for an information reproducing apparatus, wherein titles corresponding to at least one image recorded in a disk are displayed, one of the displayed titles is selected, and the image corresponding to the selected title is read from the disk and displayed on a display section. The title selecting device includes read means for reading a typical image corresponding to the selected title when a preview command is entered; and display means for displaying the read typical image superimposed on said title image displayed on the display section. In this configuration, an intended image can be selected easily and surely.

### BACKGROUND OF THE INVENTION

1. Field of the Invention

This invention relates to a title selecting device for an information reproducing apparatus which selects one of titles corresponding to images recorded in an optical disk and reads the image of the selected title and displays it on a display section.

2. Description of the Related Art

Nowadays, a rewritable large-capacity optical disk such as DVD-RW has been developed, which can record information such as images and reproduce the recorded images.

In reproduction of the recorded images, respective titles given to the recorded images are first displayed at a display section. One of the displayed titles is selected so that the image data corresponding to the selected tile is read and displayed on the display section.

As described above, conventionally, the image corresponding to the selected one of the titles displayed on the display section was read from the optical disk and displayed on the display section.

If the image displayed on the display section is different from an intended image, the reproduction is stopped. The tiles are displayed again, one of them is selected and the image corresponding to the selected title is displayed. Such a process is repeated. Therefore, it took a long time to select the intended image.

### SUMMARY OF THE INVENTION

An object of this invention is to provide a title selecting device which can surely select an intended image.

In order to attain the above object, in accordance with this invention, there is provided a title selecting device for an information reproducing apparatus, wherein titles corresponding to at least one image recorded in a disk are displayed, one of the displayed titles is selected, and the image corresponding to the selected title is read from the disk and displayed on a display section, comprising:

read means for reading a typical image corresponding to the selected title when a preview command is entered; and

display means for displaying the read typical image superimposed on the title image displayed on the display section.

In the title selecting device, the typical image is preferably superimposed on the title at the same magnifying power as that of the image recorded in the disk.

In the title selecting device, the typical image is preferably acquired by reading image information at a recording address previously recorded for each title.

In the title selecting device, preferably, the address is a leading address of the image information recorded for each title.

In the title selecting device, preferably, the typical image is a still image of the images read from the disk.

In accordance with this invention, since the typical image of the selected title can be superimposed on the title image, it can be surely decided whether or not the selected title is an intended one.

The above and other objects and features of the invention will be more apparent from the following description taken in conjunction with the accompanying drawings.

### BRIEF DESCRIPTION OF THE DRAWINGS

FIG. 1 is an arrangement view of an embodiment of this invention;

FIGS. 2 and 3 are flowcharts of the operation of the embodiment;

FIG. 4 is a view showing an example of the title recording information recorded on a title recording section;

FIG. 5 is a view showing an example of the title image recorded on a title image recording section;

FIG. 6 is a view showing a title image displayed on a display section;

FIG. 7 is a view showing an example of typical images; and

FIG. 8 is a view showing an image displayed on the display section during preview.

### DESCRIPTION OF THE PREFERRED EMBODIMENTS

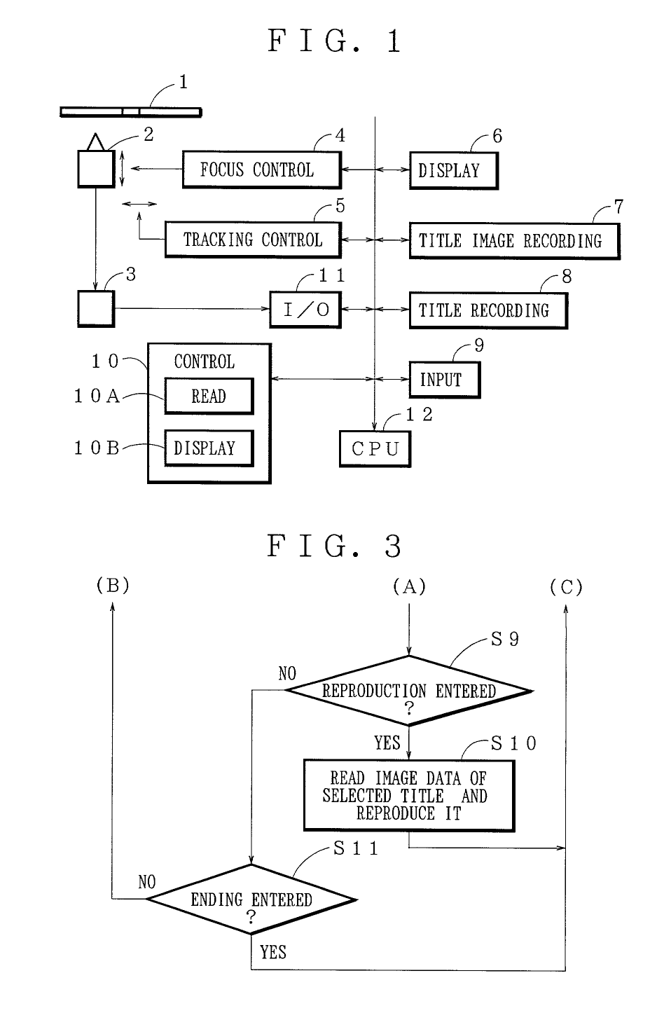

Now referring to FIGS. 1 to 3, an explanation will be given of an embodiment of this invention. FIG. 1 is an arrangement view of an embodiment of this invention.

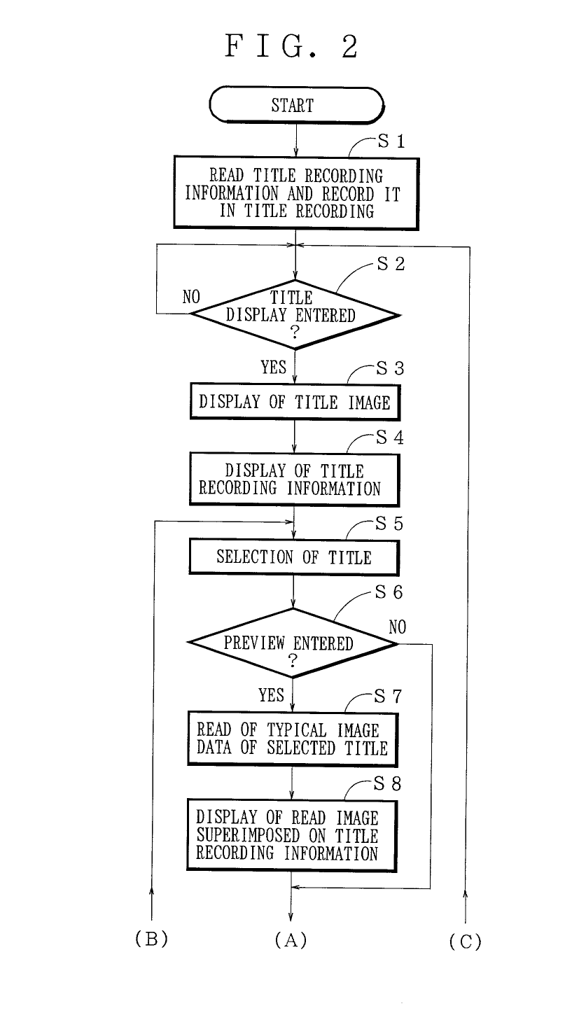

FIGS. 2 and 3 are flowcharts of the operation of the embodiment.

More specifically, FIG. 1 shows a schematic configuration of an information reproducing apparatus to which this invention is applied.

In FIG. 1, reference numeral 1 denotes an optical disk; 2 an optical pickup for reading out recorded information from the optical disk 1; 3 a light receiving element for converting an optical signal supplied from the optical pickup 1 into an electric signal; 4 a focus control section for controlling the focusing of the optical pickup 2 on the basis of an output signal from the light receiving element 3; and 5 a tracking control section for executing the tracking control of the optical pickup.

Further, reference numeral 6 denotes a display section; 7 a title recording section; 9 an input section such as a mouse, a remote controller, etc.; 10 a control section; 11 an interface (I/O) and 12 a processor (CPU) for executing processing. The operation of each of the components described above is executed under a program by CPU 12.

Referring to FIGS. 2 and 3, an explanation will be given of the operation of an embodiment of this invention.

When the optical disk 1 is set, step S1 is started.

The optical disk 1 stores title recording information at a prescribed position as shown in FIG. 4.

The title recording information is composed of a title of the image information recorded in the optical disk, recording date and a leading address, trailing address and designated address of the image information. The designated address will be described later.

In step S1, the control section 10 reads out the title recording information from the optical disk 1 and records it on the title recording section 8.

In step S2, the control section 10 waits for a title display command to be entered from the input section 9.

When the title display command is entered, in step S3, the control section 10 reads out the title image from the title image recording section 7 and displays it on the display section 6.

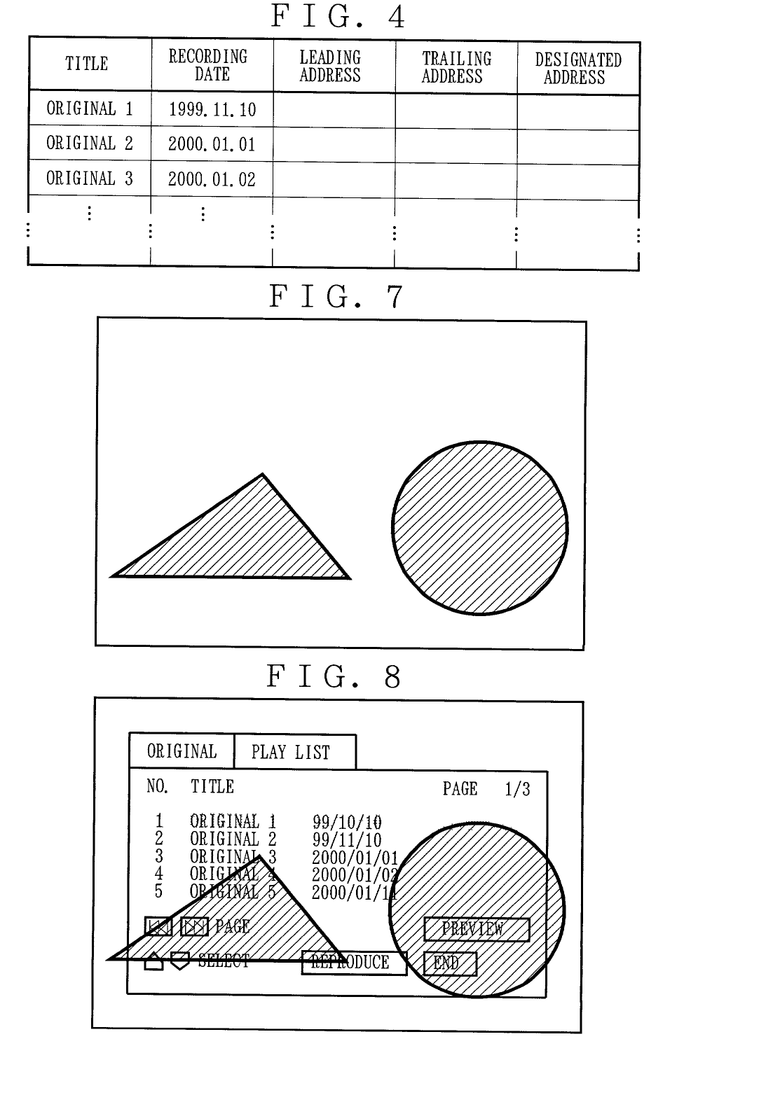

An example of the title images is shown in FIG. 5. The title image includes a page feeding key 6A, a title selecting key 6B, reproduction resuming key 6C and a preview key 6E, which are provided for facilitating an entering operation described later.

When the title image is displayed on the display section 6, in step S4, the control section 10 reads out the title recording information recorded on the title recording section 8, and displays the title recording information superimposed on the title image on the display section 6.

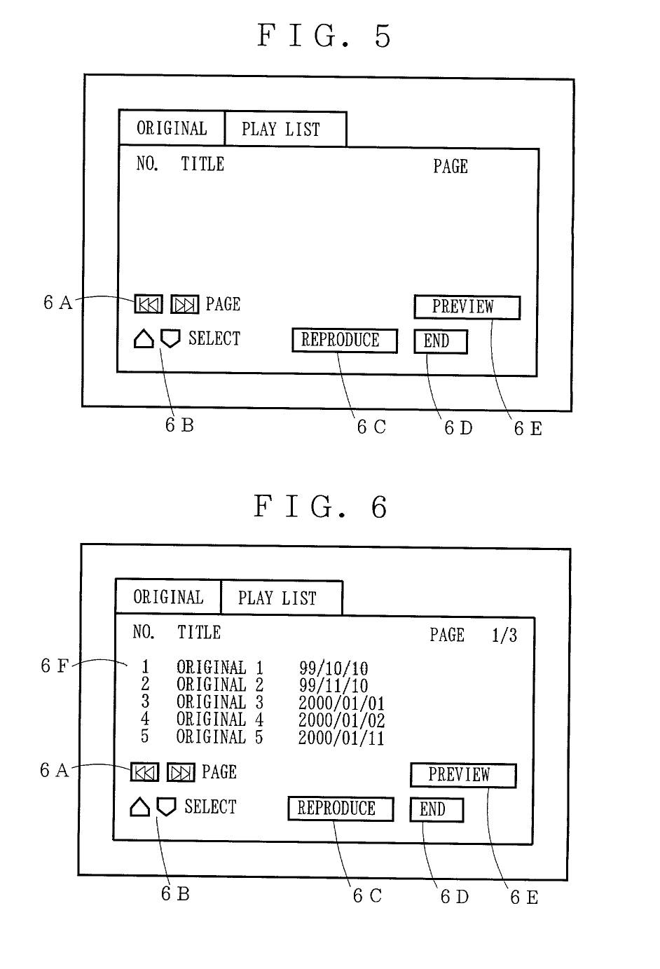

FIG. 6 shows the title recording information displayed on the display section 6. As seen, the title and recording date of the title recording information are superimposed on the title image.

In step S5, an operator executes title selection.

Specifically, when the operator shifts a cursor to the page feeding key and clicks the key, the title recording information of a subsequent title not shown is read from the title recording section 8 and displayed on the display section 6.

When the operator shifts the cursor to the title selecting key 6B, the mark denoted by 6F and indicative of “selected” is moved so that it is stopped at the intended title to select the title.

In step S6, the control section 10 decides whether or not the operator has moved the cursor to click the preview key 6E. This may be also decided according to whether or not a specified key on a remote controller has been pressed.

When a preview command has been entered, in step S7, the read means 10A of the control unit 10 reads the designated address where the typical image is recorded in the title control section 8, and reads the image information recorded at the address from the optical disk 1. In step S8, the display means 10B displays the image information superimposed on the title recording information on the display section 6.

Namely, the typical image read from the optical disk 1 in a not-reduced state (having a magnifying power equal to that of the image recoded in the optical disk 1) is superimposed on the title recording information.

FIG. 7 shows an example of a recorded image read from the designated address of the optical disk. Where the image information recorded in the optical disk is a moving image, the first one frame of the image information read from the designated address is selected in step S7 to provide a still image.

The typical image as shown in FIG. 7 read in step S7 is superimposed on the title shown in FIG. 6 to make a display as shown in FIG. 8.

In this way, since the typical image of the selected title can be superimposed on the title image, it can be easily decided whether or not the intended title has been selected.

When the operator selects the title and reproduces the image corresponding to the title thus selected, in step S9, he moves the cursor to click the reproduction key 6C shown in FIG. 5.

By the clicking, the processing advances to step S10. In step S10, the controller 10 reads the image information from the optical disk 1 from the leading address of the selected title of the title recording information recorded in the title recording section 8 and displays the read image information on the display section 6.

If the reproduction key is not clicked in step S9, in step S11, the controller 10 decides whether or not the operator moves the cursor to click an ending key, i.e. an ending has been entered. If “NO”, the processing returns to step S5 where an intended title is selected again.

If “YES” (the ending has been entered), the processing proceeds step S2. The processing corresponding to the steps S2-S11 are repeated.

In the embodiment, the information of the typical image has been acquired from the designated address indicative of the recorded position of the typical image. However, the image at the first address or address after a prescribed time has elapsed therefrom of the image information recorded in the optical disk corresponding to the intended title may be adopted as the typical image. In this case, the recording of the designated address is not required.

In place of the optical disk, any recording medium such as a magnetic disk which can be random-accessed can be used.

Incidentally, the contents of Japanese Patent Appln. No. 2000-236566(filed Aug. 4, 2000) are hereby incorporated by reference.

What is claimed is:

1. A title selecting device for an information reproducing apparatus, wherein titles corresponding to at least one image recorded in a disk are displayed, one of the displayed titles is selected, and the image corresponding to the selected title is read from the disk and displayed on a display section, comprising:
read means for reading a typical image corresponding to the selected title when a preview command is entered; and
display means for displaying the read typical image superimposed on said title image displayed on the display section.

2. A title selecting device according to claim 1, wherein said typical image is superimposed on said title at the same magnifying power as that of the image recorded in said disk.

3. A title selecting device according to claim 1, wherein said typical image is acquired by reading image information at a recording address previously recorded for each title.

4. A title selecting device according to claim 3, wherein said address is a leading address of the image information recorded for each title.

5. A title selecting device according to claim 1, wherein said typical image is a still image of the images read from said disk.
